(19) United States
(12) Patent Application Publication
(10) Pub. No.: US 2014/0013245 A1
(43) Pub. Date: Jan. 9, 2014

(54) Method and Apparatus For Controlling Display of Information Flow of Social Networking Application

(71) Applicant: International Business Machines Corporation, Armonk, NY (US)

(72) Inventors: Chang Yan Chi, Beijing (CN); Qin Ying Liao, Beijing (CN); Lin Luo, Beijing (CN); Ying-xin Pan, Beijing (CN)

(73) Assignee: International Business Machines Corporation, Armonk, NY (US)

(21) Appl. No.: 13/905,462

(22) Filed: May 30, 2013

(30) Foreign Application Priority Data
May 31, 2012 (CN) 201210177651.9

(51) Int. Cl. H04L 12/58

(52) U.S. Cl. CPC H04L 51/32
USPC 715/753

(57) ABSTRACT

A method and apparatus for controlling the display of information flow of a social networking application, where the social networking application displays a user interface for human-machine interaction at run time. The method includes displaying an information flow of the social networking application in the user interface, receiving a content item selected from the information flow by a user, determining whether the user requires to screen off the associated message of the content item, and screening off the associated message in the information flow displayed in the user interface in response to determining that the user requires to screen off the associated message of the content item.

### CROSS-REFERENCE TO RELATED APPLICATION

This application claims priority under 35 U.S.C. §119 from Chinese Patent Application No. 201210177651.9 filed May 31, 2012, the entire contents of which are incorporated herein by reference.

### BACKGROUND OF THE INVENTION

1. Field of the Invention

The present invention relates to social networking applications, and more particularly, to the control of the display of information flow of social networking applications.

2. Description of Related Art

Social networking applications have been developed rapidly in recent years. A social networking application is a network based message interaction application, with the major feature of pushing time-sequenced information flows to users according to the watch-lists that are configured by the users in advance. A typical example of social networking applications is micro-blog applications, such as the “Twitter”® application provided by Twitter Corporation® and the “Sina Weibo”® application platform provided by Sina Corporation®.

Micro-blog applications can run on many kinds of platforms like desktop, browser, and mobile terminal, featuring in convenience and ease to use. They are widely welcomed by users. According to statistics, the number of registered users of the Tweeter reached 75 million as of 2010.

The user of the micro-blog application can act as the author to instantly release a message (also known as “micro-blog post” or simply “post”) and conduct message exchange with other users, such as forwarding, commenting on and replying to posts of the other users anywhere and anytime via a variety of micro-blog application platforms connected to the network. The user can configure a watch-list containing the interested or concerned authors according to his preference in advance. Any user can also be chosen by other users to be the concerned object. In reality, some author is the concerned object of millions of users, and some users have up to hundreds of concerned objects.

When a user runs the micro-blog application on, for example, the mobile phone, the micro-blog application organizes the posts of the authors in his watch-list into a time-sequenced information flow for pushing to the mobile phone. Individual posts are short in content. However, due to the large number of authors in the watch-list and authors releasing messages frequently, the information flow will be expanded rapidly. The user needs to spend a long time in order to have a complete browse. During the browsing process, the user often becomes uninterested in a certain hot topic or becomes uninterested in a series of current messages of a certain author, but the posts containing such content emerge continuously.

The user has to view such messages, but is likely to miss the message he is really interested in. The user can configure the watch-list or themes to restrict the scope of information flow pushed, thereby controlling the display of the information flow. To do so, however, the user is required to either configure in advance or switch from a currently browsed page to the page for configuring the watch-list or themes. In addition, the user can only configure the concerned authors and the interested topics. If the user is allowed to conveniently filter out uninterested or redundant messages during the browsing process without having to switch between pages, it will save time and improve the browsing efficiency.

### SUMMARY OF THE INVENTION

In one aspect, a method for controlling the display of information flow of a social networking application, wherein the social networking application displays a user interface for human-machine interaction at run time is disclosed. The method includes displaying an information flow of the social networking application in the user interface, receiving a content item selected from the information flow by a user, determining whether the user requires to screen off the associated message of the content item, and screening off the associated message in the information flow displayed in the user interface in response to determining that the user requires to screen off the associated message of the content item.

In another aspect, an apparatus for controlling the display of information flow of a social networking application, wherein the social networking application displays a user interface for human-machine interaction at run time is disclosed. The apparatus includes a displaying module configured to display an information flow of the social networking application in the user interface, a receiving module configured to receive a content item selected from the information flow by a user, a judging module configured to determine whether the user requires to screen off the associated message of the content item, and a screening module, configured to screen off the associated message in the information flow displayed in the user interface in response to determining that the user requires to screen off the associated message of the content item.

### BRIEF DESCRIPTION OF THE DRAWINGS

The present disclosure of the above and other objects, features and advantages will become more apparent by the more detailed description of an exemplary embodiment of the present disclosure in conjunction with the accompanying drawings, wherein, in the present embodiment discloses an exemplary embodiment, the same reference numerals typically represent same member.

FIG. 1 depicts a block diagram of an exemplary computing system 100 adapted to be used to implement embodiments of the present invention;

FIG. 2 illustratively depicts a computer network system adapted to be used to implement embodiments of the present invention;

FIG. 3 illustratively depicts a user interface of a social networking application in which embodiments of the present invention can suitably be implemented;

FIG. 4 schematically depicts a flowchart of the method in accordance with an embodiment of the present inventions;

FIG. 5 is a simple representation of the a message displaying area in the user interface shown in FIG. 3;

FIG. 6A schematically shows a human-machine interaction process according to an embodiment of the present invention;

FIG. 6B schematically shows the changes in the user interface after the human-machine interaction process shown in FIG. 6A;

FIG. 6C schematically shows a human-machine interaction process according to another embodiment of the present invention;

FIG. 6D schematically shows the changes in the user interface after the human-machine interaction process shown in FIG. 6C;

FIG. 6E schematically shows part of a user interface according to an embodiment of the present invention is partial; and

FIG. 7 schematically depicts a block diagram of an apparatus in accordance with an embodiment of the present invention.

### DETAILED DESCRIPTION OF THE PREFERRED EMBODIMENTS

Preferred embodiments of the present disclosure will be described in greater detail below with reference to the accompanying drawings. The accompanying drawings have shown those preferred embodiments of the present disclosure, however, it should be understood that, the present disclosure can be implemented in various forms, but are not limited to these embodiments illustrated herein. On the contrary, these embodiments are provided for making the present disclosure more thorough and complete, such that the scope of the present disclosure can be completely delivered to one of ordinary skill in the art.

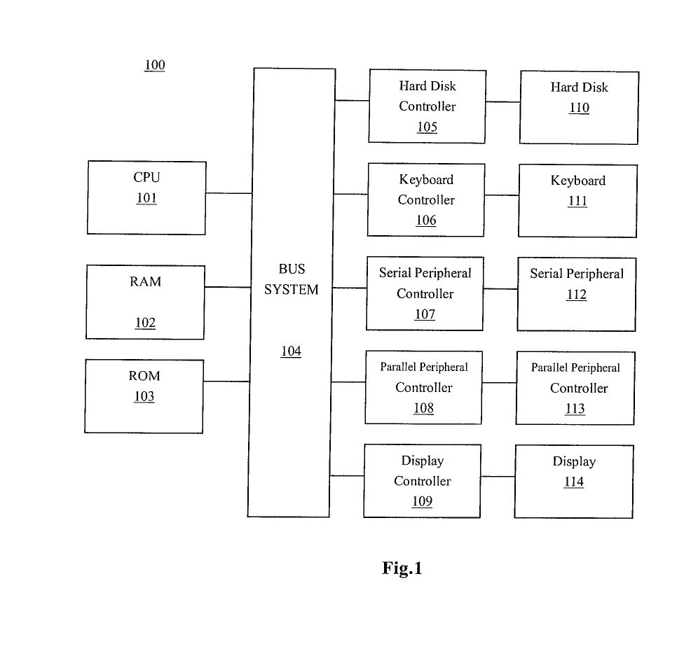

FIG. 1 shows a block diagram of an exemplary computing system 100 which is applicable to implement the embodiments of the present invention. As shown in FIG. 1, the computing system 100 can include: CPU (Central Processing Unit) 101, RAM (Random Access Memory) 102, ROM (Read Only Memory) 103, System Bus 104, Hard Drive Controller 105, Keyboard Controller 106, Serial Interface Controller 107, Parallel Interface Controller 108, Display Controller 109, Hard Drive 110, Keyboard 111, Serial Peripheral Equipment 112, Parallel Peripheral Equipment 113 and Display 114. Among above devices, CPU 101, RAM 102, ROM 103, Hard Drive Controller 105, Keyboard Controller 106, Serial Interface Controller 107, Parallel Interface Controller 108 and Display Controller 109 are coupled to the System Bus 104. Hard Drive 110 is coupled to Hard Drive Controller 105. Keyboard 111 is coupled to Keyboard Controller 106. Serial Peripheral Equipment 112 is coupled to Serial Interface Controller 107. Parallel Peripheral Equipment 113 is coupled to Parallel Interface Controller 108. And, Display 114 is coupled to Display Controller 109. It should be understood that the structure as shown in FIG. 1 is only for the exemplary purpose rather than any limitation to the present invention. In some cases, some devices can be added to or removed from the computer system 100 based on specific situations.

As will be appreciated by one of ordinary skill in the art, aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wire, optical fiber cable, RF, etc., or any suitable combination of the foregoing.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

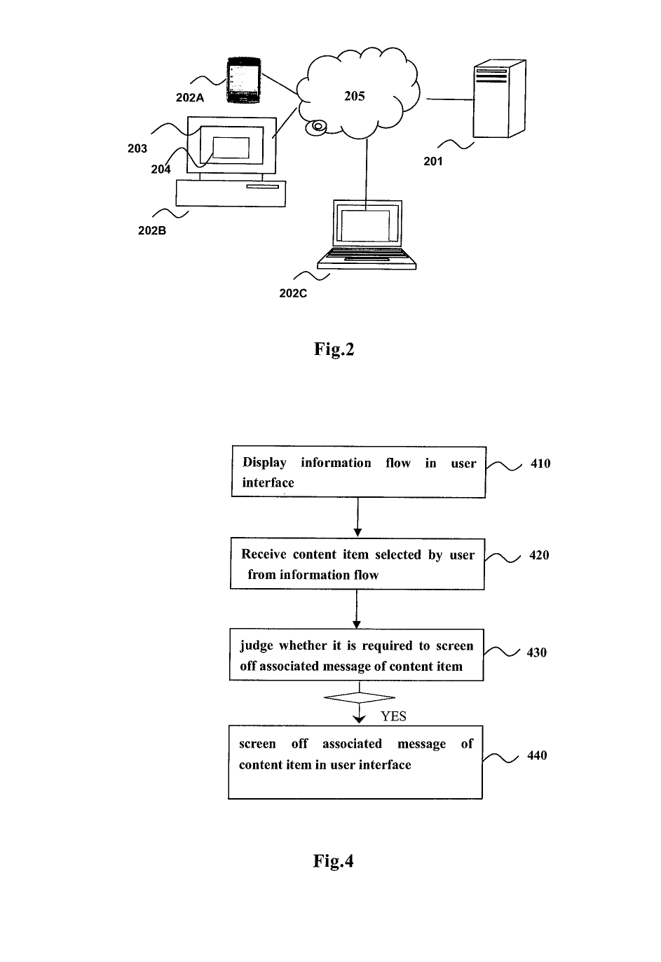

Refer further to FIG. 2, which illustratively depicts a computer network system adapted to be used to implement embodiments of the present invention.

The system shown in FIG. 2 comprises a server 201 and clients 201A, 201B, 201C that can be communicatively coupled to a communication network 205. The server 201 can be implemented with the computer system 100 shown in FIG. 1. Similarly, the clients 202A, 202B, 202C can also be implemented with the computer system 100, and embodied as desktop computer, laptop computer, smart phone, and so on.

As shown in the figure, in the monitor of the client 202, there is configured a browser 203, for example, “Mozilla Firefox”®. A social networking application, e.g., the “Sina Weibo”® application, can run on the browser 203.

When the social networking application is running, the user interface 204 for human-machine interaction is displayed in the browser 203. The user interface is programmed in, for example, the HTML programming language, and various elements in the user interface have predetermined format and determined position. The user can use the keyboard or mouse to manipulate the user interface. In the case a touch screen is used, the user interface can be manipulated directly with fingers.

Through the user interface 204, the user of the social networking application can browse messages pushed to the client by the server 201 supporting the social networking application, create and send a message, and forward a message.

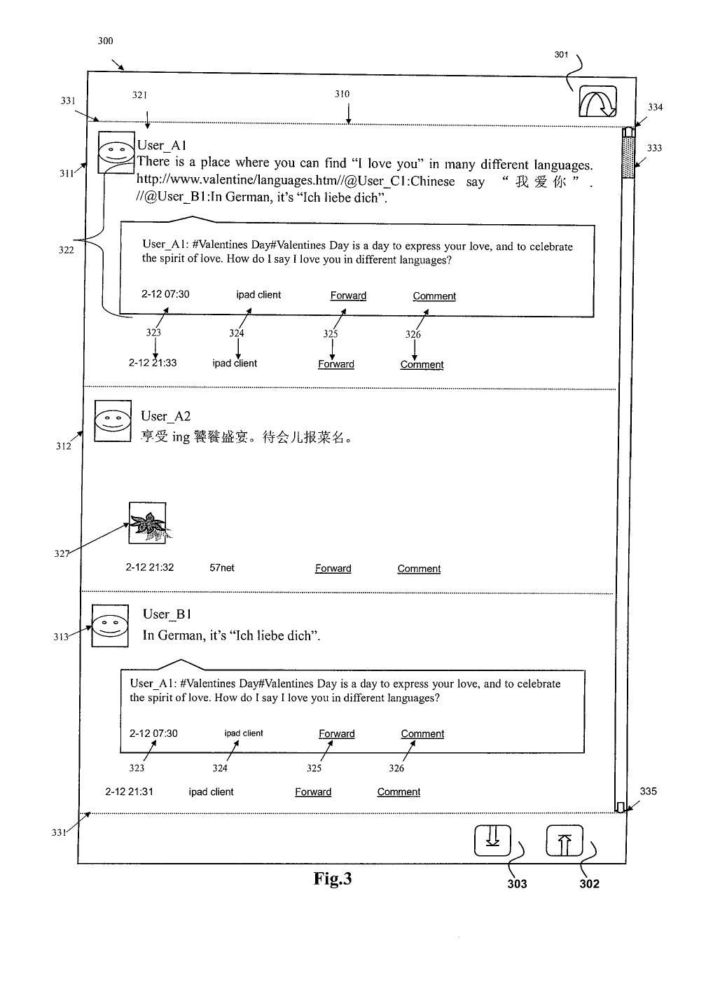

FIG. 3 can be referred to for more details on the user interface 204. FIG. 3 shows an example of user interface 300 for social networking applications in more detail. Various embodiments of the present invention can be implemented in such a user interface.

A message displaying area 310 and a plurality of control buttons 301, 302, and 303 are displayed on the user interface 300.

The message displaying area 310 is used for displaying the information flow pushed to the user currently manipulating the user interface 300. The message displaying area is also equivalent to a Web page adopting the HTML specification, in which individual elements have predetermined format and position. The current user can browse the information flow in the message displaying area 310, and can also process the information flow, for example, forward or comment on a message contained in the information flow.

The information flow is a set of messages arranged according to the time sequence. It can contain the message from an author that the current user is interested in, or the massage sent by the current user. For convenience of description, in the following description, where the context is clear, the term “user” is used to represent the user that is operating the user interface 300, the term “author” is used to represent the author that releases messages, and the term “post” is used to represent the message released by the user or the author. Where the context is clear, terms like “message” and “content” are also used to represent the “post”.

In the massage displaying area 310 shown in FIG. 3, displayed is a subset of messages contained in an information flow, which currently includes three posts 311, 312 and 313.

Each of the posts is basically of the same structure and contains the following content items: user name 321, message body 322, timestamp 323 and source 324.

For example, the first post 311 contains the user name “User_A1” (indicated by the reference number 321), the timestamp “2-12 21:33” (323) and the source “iPad client” (324), meaning that the post is released by the author with the user name of “User_A1” from “ipad client” at 9:33 p.m. on February 12.

The message body 322 contains a message created by the author “User_A1”, which is a comment by the author “User_A1” on the post of another author “User_C1” marked by the symbol “@”. Its content is <There is a place where you can find “I love you” in many different languages. http://www.valentine/languages.htm>.

The message body 322 also contains historical information, for example, the comment by the another author “User_C1” on the post of still another author “User_B1” marked by the symbol “@”: <The Chinese say “ [symbol] ”.> (The Chinese say “I love you”).

The message body 322 also contains the post forwarded by the author “User_B1”, which was released by the author “User_A1” at an earlier time, and the comment made at time of forwarding. The content of the comment reads: <In German, it's “Ich liebe dich”.>, and the content of the post forwarded is: <#Valentines Day# Valentines Day is a day to express your love, and to celebrate the spirit of love. How do I say I love you in different languages?>, wherein the text “Valentines Day” within two separators “#” denotes the topic the post is about. The timestamp “2-12 07:30” marked by the reference number 323 and the source “ipad client” marked by the reference number 324 indicate that the post was released by the author “User_A1” from “ipad client” at 7:30 on February 12.

In addition, in association with each post, it is also displayed a “Forward” function option 325 and a “Comment” function option 326 respectively for the user to choose to either forward or make comment on the associated post. It should be noted that different micro-blog applications can provide different function options. For example, some micro-blog applications only provide the “Forward” function.

The second post 312 is released by the author with the user name of “User_A2” from “57net” at 9:32 p.m. of February 12, its content including a textual message < [symbol] ing [symbol] [symbol] > (Enjoying gluttonous feast. Dish names come a little later) and a photo 327.

The third post 313 is the forwarding of and the comment on the post, which was released by the author “User_A1” at 7:30 on February 12, by the author “User_B2” at 9:31 p.m. on February 12.

Depending on the length of individual posts, the size of screen and other factors, the message displaying area 310 only displays a limited number of posts. Therefore, the message displaying area 310 can also contain a sliding bar 333, an up-moving arrow 334 and a down-moving arrow 335 available for users to manipulate. By manipulation of the sliding bar 333 and the up-moving arrow 334 or the down-moving arrow 335, other posts in the information flow can be displayed in the message displaying area 310 for continuous browsing.

As described above, in addition to the message displaying area 310, the user interface 300 can also contain control buttons available for users to manipulate, e.g., a “refresh” button 301, a “previous page” button 302 and a “next page” button 303. By clicking on the “refresh” button 301, the messages contained in the information flow can be updated, whereby updated messages are displayed in the message displaying area 310. By clicking on the “previous page” button 302 or the “next page” button 303 to turn pages, other posts can be browsed continuously.

The user interface 300 also provides an editing area (not shown) for the user to edit the message to be released.

Description of various embodiments of the present invention will be provided with reference to the accompanying drawings.

The basic idea of the present invention is to allows the user in the process of browsing an information flow of a social networking application to control the display of the information flow, so that the user can instantly filter out the post that he/she no longer wants to browse at that time merely based on the content displayed in message displaying area 310.

FIG. 4 is a high-level flowchart of the method for controlling the display of information flow of social networking applications in accordance with an embodiment of the present invention. The social networking application in the method shown in FIG. 4 displays a user interface for human-machine interaction 300 at run time. The method begins at Step 410.

In Step 410, an information flow of the social networking application is displayed in the user interface 300.

Taking the micro-blog application as the example of the social networking application, the result of the execution of Step 410 is shown in FIG. 3. When the user is running a micro-blog application like the Sina Weibo® on a client browser, the micro-blog application displays a user interface 300 for human-machine interaction in the browser, and displays an information flow of the micro-blog application in a message displaying area 310 of the user interface 300. The information flow is a set of posts pushed to the user that is currently operating the user interface 300 by the micro-blog application. At any time, the user can see only a subset of the information flow.

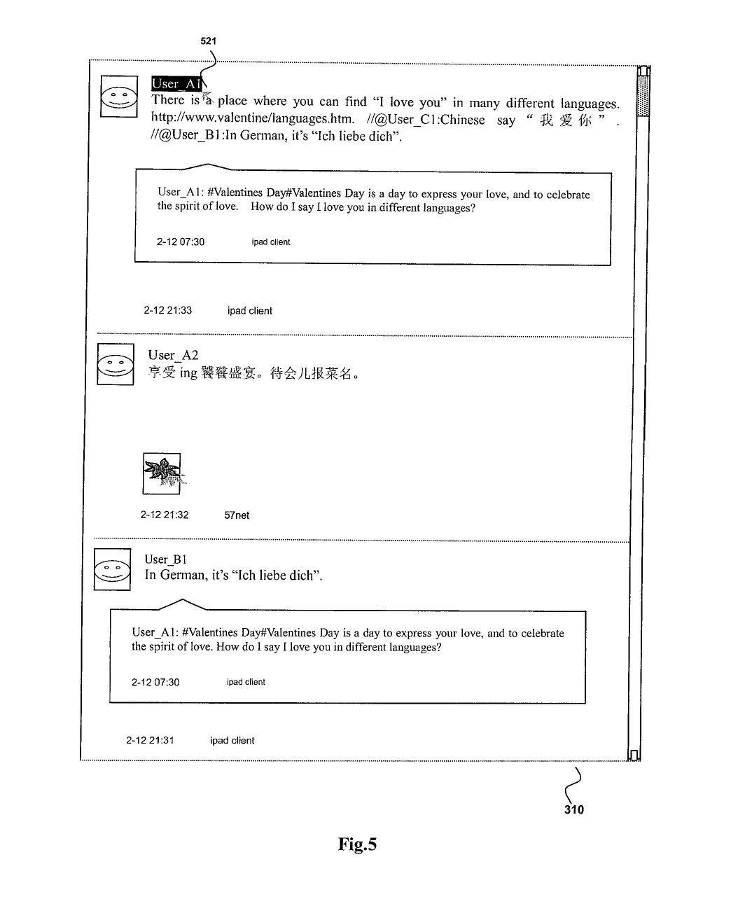

FIG. 5 is a schematic representation of the message displaying area 310 in the user interface 300 shown in FIG. 3, representing the currently displayed information flow which includes the posts from the author “User_A1”, the author “User_A2” and the author “User_B1”. Each of the posts comprises the following content items: user name 321, message body 322, time stamp 323 and source 324. Compared with FIG. 3, in FIG. 5 omitted are elements that are not directly related to embodiments of the present invention, e.g., the “Forward” function option 325 and the “Comment” function option 326.

At Step 420, a content item selected from the information flow by a user is received.

During browsing, for some reason, the user can want to filter out, for example, hide, some posts in the information flow that otherwise will be displayed, which means they will be either invisible in the user interface 300 or displayed in folded mode. Embodiments of the present invention provide such screening-off functions and, to screen off relevant posts, the user only needs to manipulate the content displayed in the message displaying area 310. Accordingly, if the user wishes to screen off some posts, he/she can first select a content item from the information flow shown in the message displaying area 310. The content item received in step 420 is such a content item.

According to an embodiment of the invention, the content item the user can select from the information flow includes the following types:
User name 321. For example, the user names “User_A1”, “User_A2” and “User_B1” of the authors of the posts 311, 312, 313 in the message displaying area 310.
Character string in the message body 322, for example, the character strings “I love you”, “Valentines Day”, “#Valentines Day# and “@User_C1” in the message body of the post 311.
Source 324, for example, “57net” in the post 312 which indicates a source.

In FIG. 5, the character strings with dark shadings are examples of content items that can be selected.

For example, as shown by the reference number 521, the user selects the content items “User_A1” by manipulating the mouse (or by fingers on a touch screen), so that the content item “User_A1” is highlighted. In Step 420, this selection action of the user is captured, thereby the content item “User_A1” is received.

Similarly, in Step 420, any character string selected by the user from the message body 322, as well as a character string representing the source 324 can be received.

After Step 420, Step 430 is performed, in which it is determined whether the user requires to screen off the associated message of the content item.

As mentioned above in description of Step 420, the content items that the user can select include user name, character string in the message body 322 and source 324. In accordance with an embodiment of the present invention, the associated message of a content item in the form of a user name is implicitly considered to be the post(s) released by the user with the user name; the associated message of a content item in the form of a character string (for example, keyword, topic name) is implicitly considered to be the post(s) containing the character string; and the associated message of a content item in the form of a source 324 is implicitly considered to be the post(s) sent from the source.

Of course, in specific implementations, it is possible to make other definitions for content item associated messages, and/or the definitions can be dynamically made by the user. For example, in some micro-blog applications, the symbol “@” in the message body 322 means that the character string immediately following it is a user name. For example, “@User_B1” means the author “User_B1”. Accordingly, it can be defined that, if a content item selected by the user is the character string “@ User_B1”, then the associated message of the content item is all posts of the author “User_B1”. As another example, a character string between the symbol “#” represents a topic name. For example, “#Valentines Day#” means the post containing it relates to the topic of “Valentines Day”. Accordingly, it can be defined that, if a content item selected by the user is the character string “#Valentines Day/#”, then the associated message of the content item is all posts relating to the topic of “Valentines Day”.

Turn to Step 430. A variety of ways can be used for determining whether the user requires to screen off the associated message of the content item.

According to an embodiment of the present invention, said determining whether the user requires to screen off the associated message of the content item comprises:

If the user selects a screening-off option in the user interface in association with a selected content item, it is determined that the user requires to screen off the associated message of the selected content item.

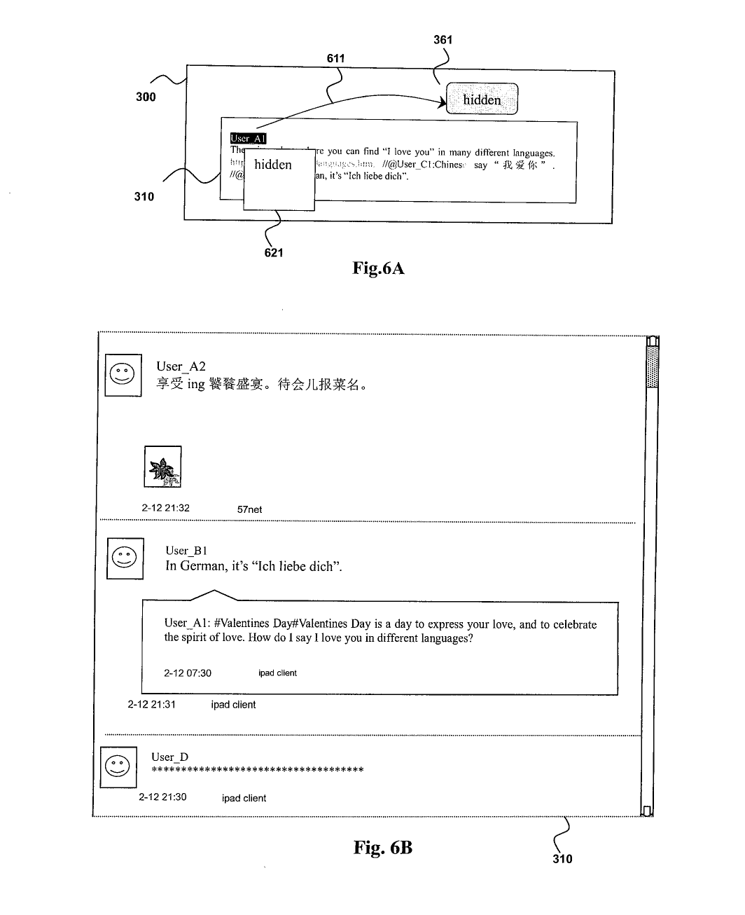

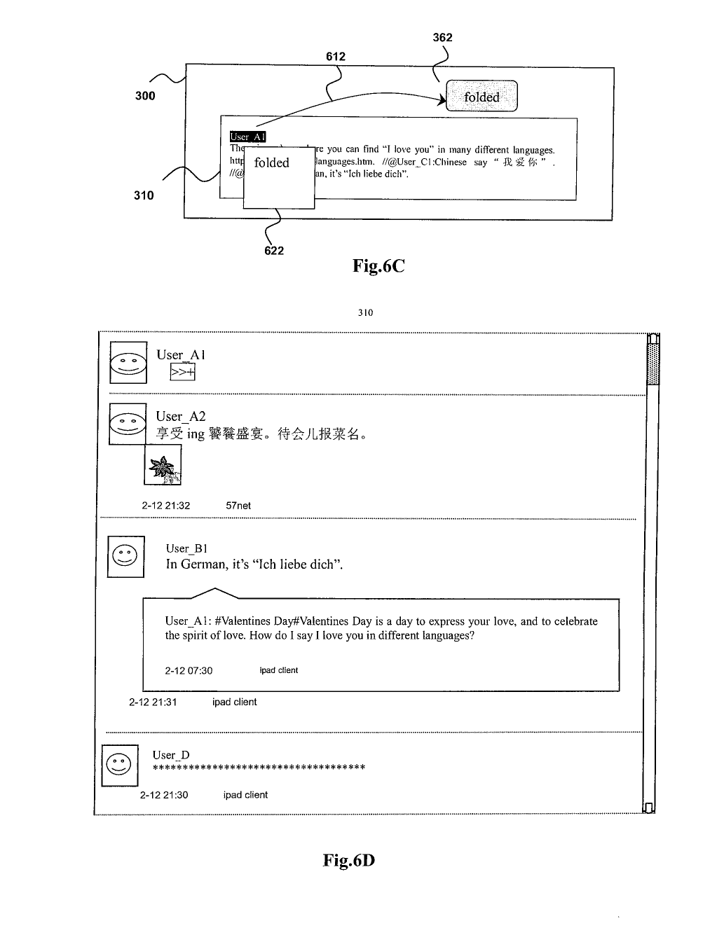

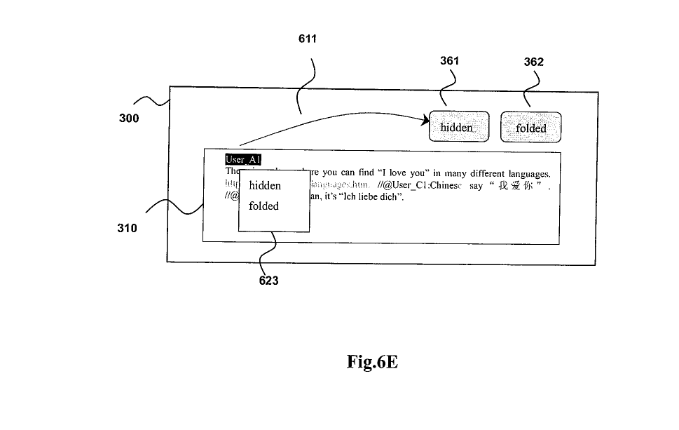

Screening-off options in the user interface are shown in FIG. 6A, FIG. 6C and FIG. 6E.

Refer first to FIG. 6A, which schematically depicts a human-machine interaction process according to an embodiment of the present invention. More specifically, it shows the process of a user selecting a screening-off option in the user interface in association with a content item.

In implementing embodiments of the present invention, the associated message of a content item can be screened off or filtered out in different ways in order to meet the different needs of users. For example, content item associated messages can be screened off in the user interface in hidden mode, or content item associated messages can be displayed in the user interface in folded mode. The process of selecting screening-off option shown in FIG. 6A, involves the hidden mode.

In FIG. 6A it is shown a “hidden” option 361 in the form of a button, the “hidden” option 361 indicating the request to hide the associated message of a content item. As shown by the arrow 611, if in Step 420 the user selects the content item “User_A1” and then drags and drops the selected content item to the “hidden” option, this indicates that the user can select the user option in association with the content item. In this case, it is determined that the user requires to screen off the associated message of the selected content item “User_A1” in hidden mode.

According to an embodiment of the invention, the hidden option 361 can be configured in the user interface 300 in advance.

According to another embodiment of the invention, in response to receiving the content item that the user selects from the information flow, the hidden option 361 is displayed in the user interface 300. For example, After the content item selected by the user from the information flow is received in Step 420, the hidden option 361 in the form of button is displayed, or a drop-down menu 621 is displayed in which a “hidden” option is included. If the user clicks on the “hidden” option in the drop-down menu 621, it is determined that the user requires to screen off the association message of the selected content item “User_A1” in hidden mode.

After Step 430, Step 440 is performed, wherein, in response to determining that the user requires to screen off the association message of the content item, the associated message is screened off in the information flow displayed in the user interface.

The user selected content item “User_A1” received in Step 430 is a user name. The result of proceeding with Step 440 is shown in FIG. 6B. Compared with FIG. 3, the posts of the author “User_A1” are hidden in the message displaying area 310 as shown in FIG. 6B. And, even if the user continues to browse by manipulation of the next page button 302 or the sliding bar 333, other posts released by the author with the selected user name of “User_A1” will not be displayed.

The above description of the embodiment of Steps 430 and 440 relates to screening off content item associated messages in hidden mode.

Those skilled in the art shall appreciate that in practical implementations of the invention, the hidden posts can be disposed of in various ways. For example, another displaying window can be opened in the user interface 300 for displaying the hidden posts; Furthermore, a user option for restoring the display of the hidden posts can be provided and if the user selects the user option, the hidden posts are restored to normal display in the message displaying area 310.

As mentioned above, the content item associated message can also be displayed in folded mode on the user interface. What is shown in FIGS. 6C and 6D is the process of screening off the messages associated with the content item in folded mode according to an embodiment of the present invention.

FIG. 6C schematically depicts a human-machine interaction process according to an embodiment of the present invention. More specifically, the Figure depicts the process of a user selecting another screening-off option in the user interface in association with a content item.

Compared with FIG. 6A, in FIG. 6C the folded option 362 is used in place of the hidden option 361 of FIG. 6A, and the drop-down menu 622 containing a “folded” option is used in place of the drop-down menu 621 containing the “hidden” option.

In this case, if the user drags and drops the selected content item “User_A1” to the folded option 362, as shown by the reference number 612, or selects the “folded” option in the drop-down menu 622, then in Step 430 it is determined that the user requires to screen off the associated message of the selected content item “User_A1” in folded mode.

Accordingly, the result of the execution of Step 440 is shown as in FIG. 6D. Compared with FIG. 6B, In FIG. 6D only the content item “User_A1” and the icon “>+” are displayed, which means that the posts sent by the author with the user name of “User_A1” are folded. If the user clicks on the icon “>>+”, the folded posts can be expanded.

Similar to above with respect to the hidden mode, in practical implementations of the present invention, a user option for restoring the display of the folded posts can be provided on the user interface 300. If the user selects the user option, the associated message folded will be restored to normal display in the message displaying area 310.

Embodiments of the inventions, in particular the implementation of Steps 430 and 440, are described above with reference to FIGS. 6A-6D and taking the user name as an example of the content item in the information flow of the social networking application. It should be noted that the above description is merely exemplary, and various modifications are possible in the specific practice. For example, the user interface shown in FIG. 6A and FIG. 6C can be replaced with the user interface as shown in FIG. 6E, i.e., the hidden option 361 and the folded option 362 are simultaneously displayed on the user interface 300, and/or the text “hidden” and “folded” respectively representative of the hidden mode and the folded mode can be simultaneously included in a single drop down menu 623.

Furthermore, as mentioned above, as an example in the above-described embodiments, the content item is a user name, for example, “User_A1”. The associate message of the content item is the posts released by the author with the user name of “User_A1”.

If, in Step 420, the content item selected by the user is a character string in the message body 322, then the associated message of the content item is all posts that contain the character string. The manner of screening off the associated message of the content item is similar to that respectively shown in FIG. 6B and FIG. 6D. For example, the content item selected by the user is “Valentines Day”. If the screening-off manner is “hidden”, then the post of which the message body contains “Valentines Day” will not be displayed in the content displaying area 310. If the screening-off manner is “folded”, then only the content item “Valentines Day” and the icon “+” will be displayed in the content displaying area 310 for the post of which the message body contains the character string.

If, in Step 420, the content item selected by the user is source 324, then the associated message of the content item is all of the messages or posts sent from the source 324. The manner of screening off the associated message of the content item is similar to that respectively shown in FIG. 6 B and FIG. 6D. For example, the user has viewed the content of the author “User_A2” sent from the 57net, which is the content that he is not interested in. Perhaps he feels that there can be similar posts of other of his concerned authors sent from the 57net. So he selects the content item “57net”, which is the source of the message. If the screening-off manner is “hidden”, then none of the message or post sent from the source represented by the “57net” will be displayed in the content displaying area 310. If the screening-off manner is “folded”, then only the content item “57net” and the icon “+” will be displayed in the content displaying area 310 for the post sent from the source represented by the “57net”.

As mentioned above, the types of the content item selected by the user in Step 420 include user name 321, character string in the message body 322 and source 324.

According to an embodiment of the present invention, the type of the content item selected by the user can be identified in Steps 420, 430 and 440.

For example, in the Web browser, the Web page is displayed in the HTML language. The content in the message displaying area 310 is also displayed in the HTML language, of which, user name, 321, message body 322 and source 324 respectively belong to different HTML elements, occupy respective positions in the message displaying area 310 and thus are marked with different HTML tags in the HTML document corresponding to the message displaying area 310. In the case that user selected content item is received, whether the type of the content item belong to the user name 321, the character string in the message body 322 or the source 324 can be identified according to the tags for indentifying the content items in the HTML document.

In accordance with an embodiment of the present invention, for example, a screening rule can be generated after it is determined, in Step 430 that the user requires to screen off the associated message of the content item.

The screening rule can be denoted by a tuple {content item, type}, wherein the “content item” denotes the content item selected by the user in the information flow, and the “type” denotes the type of the content item.

For example, the screening rule {User_A1, author} indicates that all posts released by author named “User_A1” shall be screened off; the screening rule {“Valentines Day”, message body} indicates that all messages or posts of which the message body contains the character string “Valentines Day” shall be screened off, and the screening rule {57net Source} indicates that all messages or posts sent from the source indicated by “57net” shall be screened off.

Such screening rules can be stored in a rule library. When the server 202 pushes the information flow, the screening rules in the rule library can be applied to the information flow prior to being displayed in the message displaying area 310.

The screening rules can be further divided into hiding rules and folding rules, and the hiding rules and the folding rules can be respectively saved in a hiding rule library and a folding rule library. For example, the hiding rule {“User_A1”, author} indicates that the post released by the author identified by the content item “User_A1”, i.e., the post released by the author with the user name “User_A1”, shall be screened off in hidden mode. The folding rule {User_A1 author} indicates that the post released by the author identified by the content item “User_A1” shall be screened off in a folding manner.

The screening rules of various screening-off manners can also represented by a triple {content item, type, screening manner}, wherein the “screening manner” indicates the manner in which the content item associated message shall be screened off. For example, the screening rules {User_A1, author, hiding} and {User_A1, author, folding} respectively indicate that the post released by the author “User_A1” shall be screened off in hidden mode and in folded mode.

Various embodiments of the method for controlling the display of information flow of a social networking application have been described. According to the same inventive concept, the present invention also discloses an apparatus for controlling the display of information flow of a social networking application.

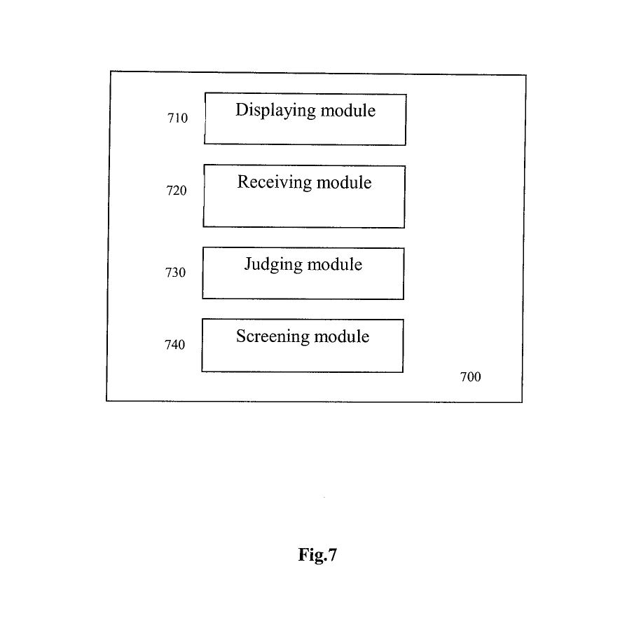

FIG. 7 is a block diagram which schematically depicts the apparatus 700 for controlling the display of information flow of a social networking application according to an embodiment of the present invention, wherein the social networking application displays a user interface for human-machine interaction at run time. As shown in the figure, the apparatus comprises a displaying module 510, a receiving module 510, a judging module 530 and a screening module 540.

The displaying module is configured to display an information flow of the social networking application in the user interface. The receiving module 520 is configured to receive a content item selected from the information flow by a user. The judging module 530 is configured to determine whether the user requires to screen off the associated message of the content item. The screening module 540 is configured to screen off the associated message in the information flow displayed in the user interface in response to determining that the user requires to screen off the associated message of the content item.

According to an embodiment of the invention, the judging module is configured to determine that the user requires to screen off the associated message of the content item associated message if the user selects a screening-off option in the user interface in association with the content item.

According to an embodiment of the invention, the screening-off option is displayed in the user interface in advance.

According to an embodiment of the invention, the screening-off option is displayed in the user interface in response to receiving the content item that the user selects from the information flow.

According to an embodiment of the invention, the screening module is configured to hide the associated message in the user interface.

According to an embodiment of the invention, the screening module is configured to display the associated message in folded mode in the user interface.

According to an embodiment of the invention, the apparatus 700 further comprises a module configured to identify the type of the content item.

According to an embodiment of the invention, the content item is a user name, and the screening module 540 is configured to screen off all messages released by the author with the user name in the user interface.

According to an embodiment of the invention, the content item is a character string in the message body of a message in the information flow, and the screening module 540 is configured to screen off all messages containing the character string in the user interface.

According to an embodiment of the invention, the character string is the topic name of the message, and the screening module is configured to screen off all messages with the topic name in the user interface.

According to an embodiment of the invention, the content item is the source of the message in the information flow, and the screening module is configured to screen off all messages from the source in the user interface.

Various embodiments of the apparatus for controlling the display of information flow of a social networking application are described above. Since description of methods for controlling the display of information flow of a social networking application has been provided in previous paragraphs, in the description of the apparatus, some duplicate contents in the description of the method for controlling the display of information flow of a social networking application are omitted.

For the consideration of avoiding infringement of intellectual property rights and personal privacy, the examples in the specification are provided based on practical applications with substituted details. Those skilled in the art shall appreciate that these examples are adequate to illustrate that various embodiments of the invention can be applied to more general cases, and therefore do not constitute any limitation on a variety of possible embodiments of the invention. In addition, in the specification, the micro-blog application is taken mainly as the example of social networking applications for describing various embodiments of the invention. Those skilled in the art shall appreciate that the various embodiments described above can obviously be easily extended to other social networking applications that display information flows in a similar manner.

Embodiments of the invention have been described. The above description is only exemplary, rather than exhaustive or limited to the embodiments disclosed. Those skilled in the art shall appreciate that various modifications and alterations changes thereto can be readily made. The choice of terms herein is intended for best explaining the principle, practical application or improvement to the techniques in the market of the embodiments, or allowing those skilled in the art to understand various embodiments disclosed herein.

We claim:

1. A method for controlling the display of information flow of a social networking application, wherein the social networking application displays a user interface for human-machine interaction at run time, the method comprising:
displaying an information flow of the social networking application in the user interface;
receiving a content item selected from the information flow by a user;
determining whether the user requires to screen off the associated message of the content item; and
screening off the associated message in the information flow displayed in the user interface in response to determining that the user requires to screen off the associated message of the content item.

2. The method of claim 1, wherein said determining whether the user requires to screen off the associated message of the content item comprises:
if the user selects a screening-off option in the user interface in association with the content item, determining that the user requires to screen off the associated message of the content item.

3. The method of claim 2, wherein, in response to receiving the content item that the user selects from the information flow, displaying the screening-off option in the user interface; or
displaying the screening-off option in the user interface in advance.

4. The method of claim 1, wherein said screening off the associated message in the information flow displayed in the user interface comprises:
hiding the associated message in the user interface; or
displaying the associated message in folded mode in the user interface.

5. The method of claim 3, further comprising:
identifying the type of the content item.

6. The method of claim 5, wherein the content item is a user name, and said screening off the associated message in the information flow displayed in the user interface in response to determining that the user requires to screen off the associated message of the content item comprises:
screening off all messages released by the author with the user name in the user interface.

7. The method of claim 5, wherein the content item is a character string in the message body of a message in the information flow, and said screening off the associated message in the information flow displayed in the user interface in response to determining that the user requires to screen off the associated message of the content item comprises:
screening off all messages containing the character string in the user interface.

8. The method of claim 7, wherein the character string is the topic name of the message, and said screening off the associated message in the information flow displayed in the user interface in response to determining that the user requires to screen off the associated message of the content item comprises:
screening off all messages with the topic name in the user interface.

9. The method of claim 5, wherein the content item is the source of the message in the information flow, and said screening off the associated message in the information flow displayed in the user interface in response to determining that the user requires to screen off the associated message of the content item comprises:
screening off all messages from the source in the user interface.

10. An apparatus for controlling the display of information flow of a social networking application, wherein the social networking application displays a user interface for human-machine interaction at run time, the apparatus comprising:
a displaying module, configured to display an information flow of the social networking application in the user interface;
a receiving module, configured to receive a content item selected from the information flow by a user;
a judging module, configured to determine whether the user requires to screen off the associated message of the content item; and
a screening module, configured to screen off the associated message in the information flow displayed in the user interface in response to determining that the user requires to screen off the associated message of the content item.

11. The apparatus of claim 10, wherein the judging module is configured to determine that the user requires to screen off the associated message of the content item associated message if the user selects a screening-off option in the user interface in association with the content item.

12. The apparatus of claim 11, wherein the screening-off option is displayed in the user interface in response to receiving the content item that the user selects from the information flow; or
the screening-off option is displayed in the user interface in advance.

13. The apparatus of claim 1, wherein the screening module is configured to hide the associated message in the user interface or display the associated message in folded mode in the user interface.

14. The apparatus of claim 12, further comprising:
a module configured to identify the type of the content item.

15. The apparatus of claim 14, wherein the content item is a user name, and the screening module is configured to screen off all messages released by the author with the user name in the user interface.

16. The apparatus of claim 14, wherein the content item is a character string in the message body of a message in the information flow, and the screening module is configured to screen off all messages containing the character string in the user interface.

17. The apparatus of claim 16, wherein the character string is the topic name of the message, and the screening module is configured to screen off all messages with the topic name in the user interface.

18. The apparatus of claim 14, wherein the content item is the source of the message in the information flow, and the screening module is configured to screen off all messages from the source in the user interface.
